(19) United States
(12) Patent Application Publication
(10) Pub. No.: US 2018/0007994 A1
(43) Pub. Date: Jan. 11, 2018

(54) Wearable integration with helmet

(71) Applicant: BRAGI GmbH, Munchen (DE)

(72) Inventors: Peter Vincent Boesen, Munchen (DE); Darko Dragicevic, Munchen (DE)

(73) Assignee: BRAGI GmbH, Munchen (DE)

(21) Appl. No.: 15/643,848

(22) Filed: Jul. 7, 2017

Related U.S. Application Data
(60) Provisional application No. 62/360,381, filed on Jul. 9, 2016.

(51) Int. Cl. A42B 3/30; H04M 1/05; H04R 1/10; H04R 1/00

(52) U.S. Cl. CPC A42B 3/30; H04R 1/105; H04B 1/385; H04M 1/05; H04R 1/00

(57) ABSTRACT

A system includes a safety helmet and an earpiece, wherein the earpiece is configured to determine when a user of the earpiece is wearing the safety helmet. The earpiece may include a touch surface and at least one sensor associated with the touch surface and wherein the earpiece is configured to ignore input at the touch surface when the user of the earpiece is wearing the safety helmet. A method includes sensing by an earpiece that a user is wearing a helmet and deactivating sensors associated with a touch input area on the ear piece when the user is wearing the helmet. A method includes charging an earpiece using a battery of a helmet while a user is wearing the earpiece and the helmet. A method includes communicating data from one or more sensors of a helmet or one or more sensors of a motorcycle to an earpiece and providing audio output indicating of the data to a user through a speaker of the earpiece.

### PRIORITY STATEMENT

This application claims priority to U.S. Provisional Patent Application No. 62/360,381, filed Jul. 9, 2016, and entitled “Wearable integration with helmet”, hereby incorporated by reference in its entirety.

### FIELD OF THE INVENTION

The present invention relates to wearable devices. More particularly, but not exclusively, the present invention relates to ear pieces.

### BACKGROUND

Despite certain freedoms associated with riding a motorcycle as opposed to a car or similar vehicle, there are a number of limitations imposed on a driver of a motorcycle. For example, motorcycles do not provide audio feedback to drivers. What is needed are systems which use earpieces to augment and improve the driving experience for motorcycle drivers, improve safety, improve performance, or are otherwise beneficial and desirable.

### SUMMARY

Therefore, it is a primary object, feature, or advantage of the present invention to improve over the state of the art.

It is a further object, feature, or advantage of the present invention to improve the driving experience of a motorcycle through use of one or more earpieces.

It is a still further object, feature, or advantage of the present invention to improve motorcycle safety through use of one or more earpieces.

A further object, feature, or advantage is to audible provide information to a driver of a motorcycle.

A still further object, feature, or advantage is to integrate use of an earpiece and use of a helmet

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

According to one aspect, a system includes a safety helmet and an earpiece, wherein the earpiece is configured to determine when a user of the earpiece is wearing the safety helmet. The earpiece may include a touch surface and at least one sensor associated with the touch surface and wherein the earpiece is configured to ignore input at the touch surface when the user of the earpiece is wearing the safety helmet. The system may further include a battery disposed within the safety helmet and wherein the safety helmet is configured to charge a battery of the earpiece when the user is wearing the earpiece and the helmet. The battery may then be charged inductively. The system may include at least one sensor in the safety helmet and wherein the safety helmet comprises a transceiver for communicating data from the at least one sensor in the safety helmet to the earpiece. The at least one sensor may include a plurality of microphones, an imaging sensor, an inertial sensor, a physiological sensor, or other type of sensor. The earpiece may include an earpiece housing and at least one inertial sensor in the earpiece. The earpiece may be configured to determine if a crash has occurred using data sensed by the at least one inertial sensor. The earpiece may be configured to initiate a communication regarding a crash to a remote location if the earpiece has determined that the crash has occurred. The communication may be a phone call, a text message, or other communication. The communication may include at least one of a location, an identity of the user, and physiological information of the user. The earpiece may be configured to provide audio feedback of information derived from sensors of the helmet. The earpiece may be configured to provide audio feedback of information derived from sensors of a motorcycle. The helmet may include at least one air bag and the earpiece may be configured to send a signal to the helmet to deploy the at least one air bag if the earpiece determines that a crash is imminent using data from the at least one inertial sensor. The earpiece may include a speaker and the earpiece may be configured to provide audio feedback to a user to assist in coaching the user in operating a motorcycle. The system may further include an article of clothing having an air bag and wherein the earpiece may be configured to send a signal to the article of clothing to deploy the air bag. The article of clothing may be a race suit, a jacket, a vest, a collar or other article of clothing.

According to another aspect, an earpiece includes an earpiece housing, a processor disposed within the earpiece housing, and a touch surface on an outer portion of the earpiece housing for receiving user input from a user. The earpiece is configured to determine when a user of the earpiece is wearing a safety helmet and to deactivate sensors associated with the touch surface if the user is wearing the helmet.

According to another aspect, a method includes sensing by an earpiece that a user is wearing a helmet, and deactivating sensors associated with a touch input area on the ear piece when the user is earing the helmet.

According to another aspect, a method includes charging an earpiece using a battery of a helmet while a user is wearing the earpiece and the helmet. The charging may be inductive charging.

According to another aspect, a method includes communicating data from one or more sensors of a helmet to an earpiece and providing audio output indicating of the data to a user through a speaker of the earpiece.

According to another aspect, a method includes communicating data from one or more sensors of a motorcycle to an earpiece and providing audio output indicating of the data to a user through a speaker of the earpiece.

### BRIEF DESCRIPTION OF THE DRAWINGS

FIG. 1 is a pictorial representation of a system.

FIG. 2 illustrates a set of earpieces including a left earpiece and a right earpiece in greater detail.

FIG. 3 illustrates a block diagram of one example of an earpiece.

FIG. 4 illustrates a block diagram of a safety helmet.

FIG. 5 illustrates one example of a helmet with a plurality of sensors.

FIG. 6 illustrates one example of a motorcycle control system.

### DETAILED DESCRIPTION

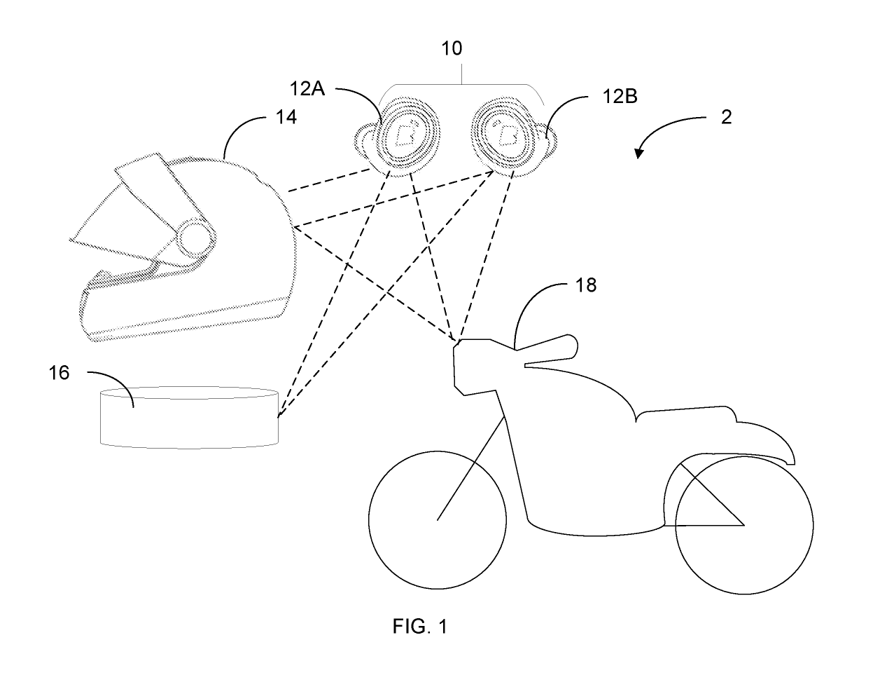

FIG. 1 illustrates various systems 2. As shown in FIG. 1 there is a pair of earpieces 10, which includes a left earpiece 12A and a right earpiece 12B. A safety helmet 14 for a motorcyclist who rides a motorcycle 18 is shown. The helmet 14 may be an augmented-reality helmet which includes a display. The 14 helmet may include a battery pack mounted in the helmet at a location corresponding with a base of the motorcyclist's skull. The helmet 14 may also include one or more cameras such a rear-view camera. The helmet 14 may also include one or more sensors. Also shown in FIG. 1 is an example of an article of clothing in this case a collar 16 which may include an air bag. As will be discussed later herein, various other types of clothing may include an air bag including jackets, vests or racing suits. In addition, one or more air bags may be located in the motorcycle 18.

In operation, the set of earpieces 10 may communicate with the helmet 14, the motorcycle 18, and/or the article of clothing 16. This communication may occur to support any number of functions. For example, sensors within the earpiece(s) may be used to collect information, to process information from sensors in the helmet 14, clothing 16, or motorcycle 18, or to provide information to displays within the helmet 14 or the motorcycle 18, or to activate an air bag associated with the article of clothing 16.

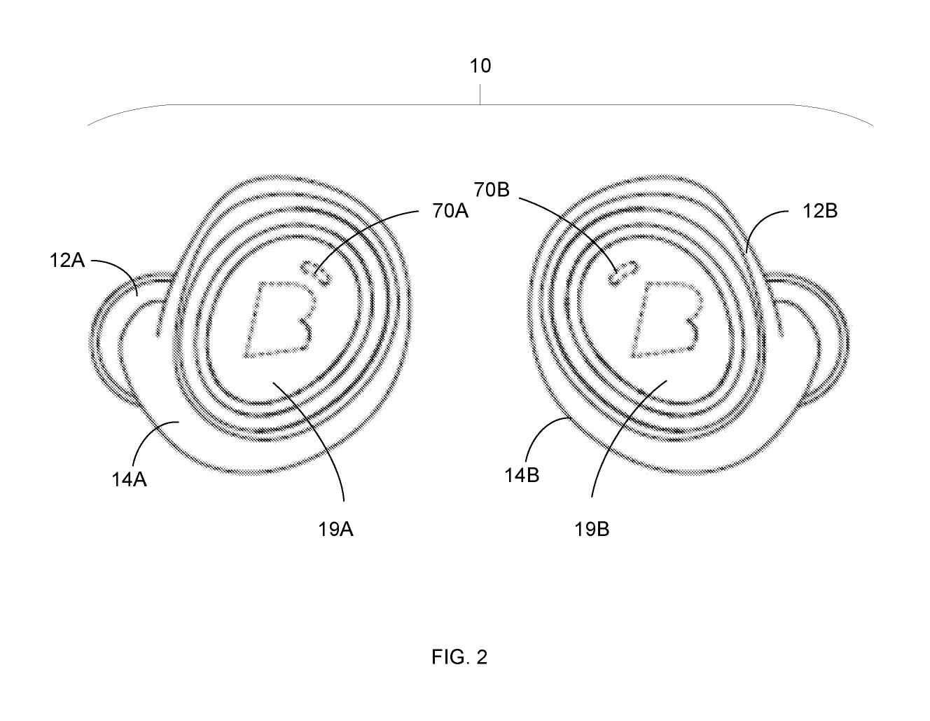

FIG. 2 illustrates the set of earpieces 10 including the left earpiece 12A with a left earpiece housing 14A and the right earpiece 12B with a right earpiece housing 14B. An external microphone 70A is present on the left earpiece 12A and another external microphone 70B is present on the right earpiece. More than one external earpiece may be present on each earpiece. A touch area 19A is present on the left earpiece and a touch area 19B is present on the right earpiece. In operation, a user may control functionality of the earpieces through interacting through the touch interface. This may include tapping on the touch area, swiping across the touch area (with different directionality having potentially different meaning), or holding a finger against the touch area. The touch area may be implemented in any number of ways such as through optical emitters and detectors, capacitive sensing or otherwise.

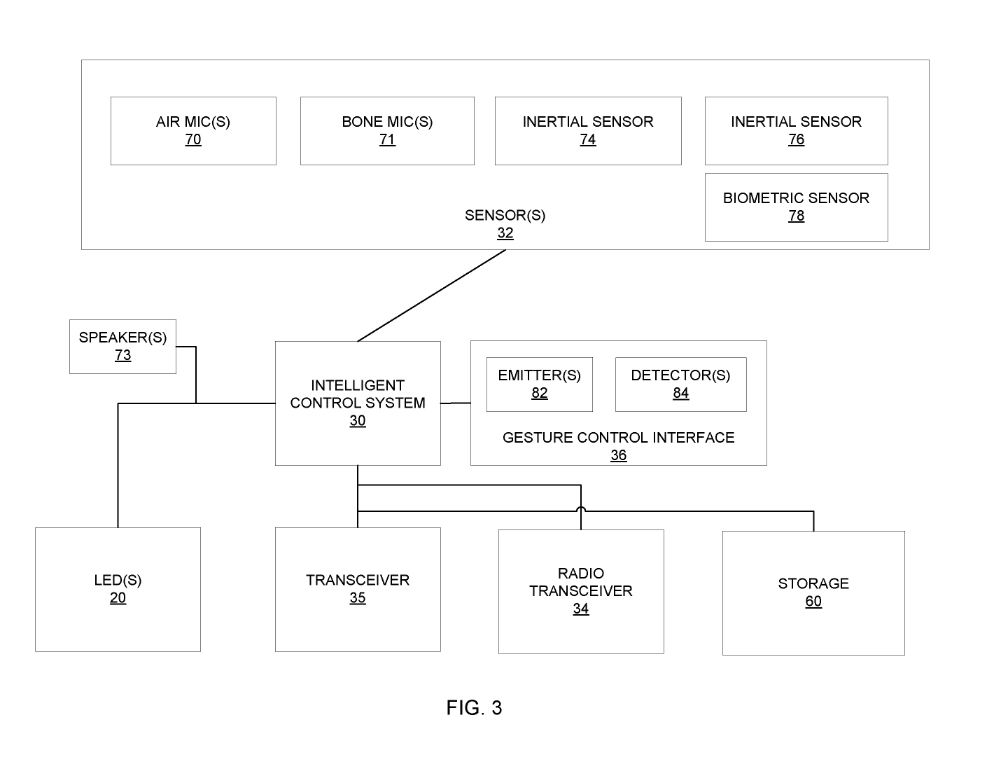

FIG. 3 illustrates one example of a block diagram of an earpiece. As shown in FIG. 3, the earpiece may include one or more sensors 32. Examples of sensors may include an air microphone 70, a bone microphone 71, an inertial sensor 74, another inertial sensor 76, and one or more biometric or physiological sensors 78. The inertial sensors 74, 76 may include accelerometers, gyros, or other types of inertial sensors. The biometric sensors 78 may include any number of different physiological sensors including heart rate monitors, pulse oximeters, temperature sensors, or other type of physiological sensors. An intelligent control system 30 is shown which may comprise one or more processors. A gesture control interface 36 is operatively connected to the intelligent control system 30. The gesture control interface 36 may include one or more emitters and one or more detectors 84 which are used to sense gestures of a user such as a user tapping, holding, or swiping across a touch area of the earpiece. The sensors may provide for capacitive sensing, infrared sensing, other types of light sensing, or other type of emittance and reception to detect types of gestures performed at a touch surface of the earpiece. The intelligent control system 30 is also operatively connected to one or more speakers 73, one or more light elements such as LEDs 20, a memory or storage unit 60, and one or more transceivers 34, 35 which may include a wireless radio transceiver 34 such as may be used for Bluetooth or Bluetooth Low Energy (BLE) communications, or WiFi communications, ultra-wideband, or other type of wireless radio communications such as with other wearable devices, with the motorcycle or other vehicle, with the helmet, with a protection system or otherwise. The transceiver 35 may be a near field magnetic inductance (NFMI) or other type of transceiver which may be used to communicate between earpieces and/or for other purposes as well.

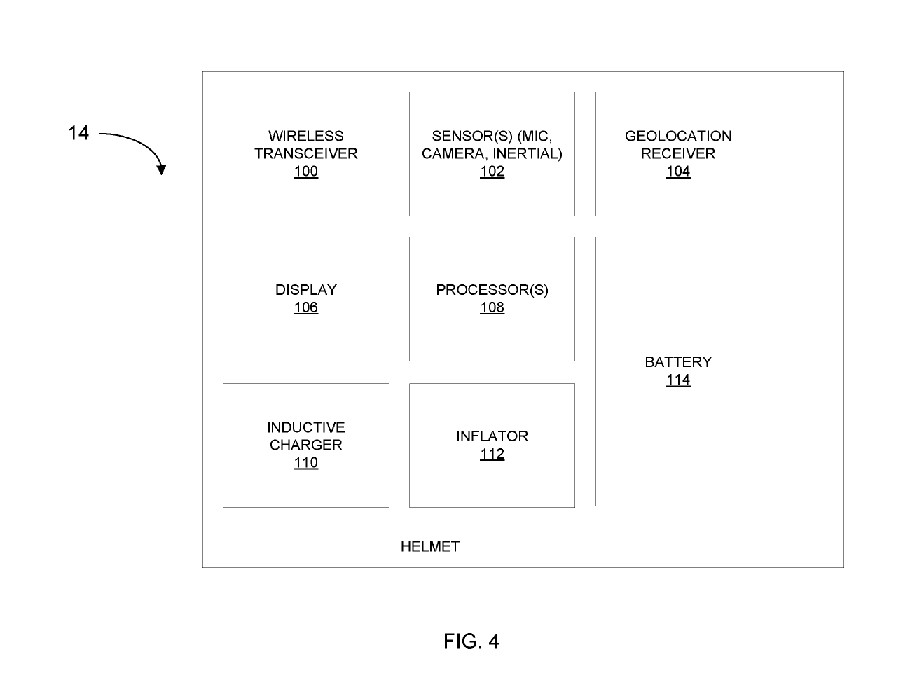

FIG. 4 illustrates one example of a block diagram for a helmet 14. The helmet 14 may be an augmented-reality helmet which includes one or more displays 106. The 14 helmet may include a battery pack 114 mounted in the helmet at a location corresponding with a base of the motorcyclist's skull. The helmet may include a processor 108 which may be operatively connected to the other electronic components within the helmet including a wireless transceiver 100, sensors such as microphones, cameras, and inertial sensors 102, a geolocation receiver 104 such as a GPS receiver, an inductive charger 110, and an inflator 112. Sensors of the helmet 14 may be used to sense parameters associated with the environment. The processor(s) 108 may be used to receive a signal from the at least one sensor and determine a probability that a safety incident may occur based upon the at least one feature. This probability may be compared to a threshold and if the threshold is exceeded, information may be displayed on the display 106 or other action may be taken. The helmet may be used for blind spot detection, forward collision alert, rear collision alert, cross-traffic alert, merging-traffic alert, lane departure warning, and traffic sign recognition.

### Audio Feedback

The earpieces may provide for audio feedback to a user. Where sensors of the earpiece, of the helmet, of the motorcycle (or other vehicle) sense information, this information or that which can be derived from this sensed information may be conveyed to the driver and/or passenger(s) of the motorcycle or other vehicle through audio. For example, any information present on a display of a helmet may be communicated via audio in addition to being displayed or instead of being displayed.

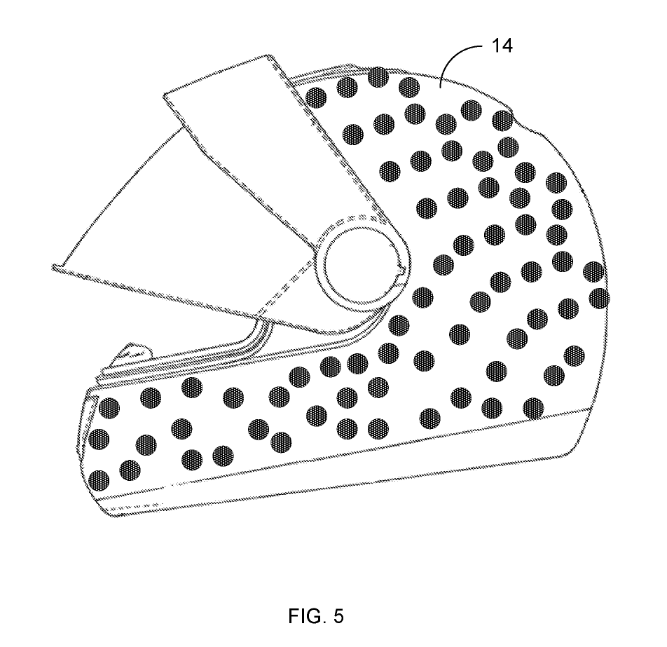

It is also contemplated that a helmet may be used to provide any number of different sensors to make available for the earpiece. For example, a helmet may be embedded with a plurality of different microphone sensor elements and audio may be received from all or a subset of these different microphone sensor elements. FIG. 5 illustrates one example of a helmet 14 where there are a plurality of different microphone elements presents which may be printed on the helmet. It is contemplated that a determination may be made as to which of these different audio streams to access at a time. Thus, for example a single microphone within a particular region may be used. It is noted, that having audio streams from different directions may be used to identify the location of a particular audio source, or provide other information about the environment.

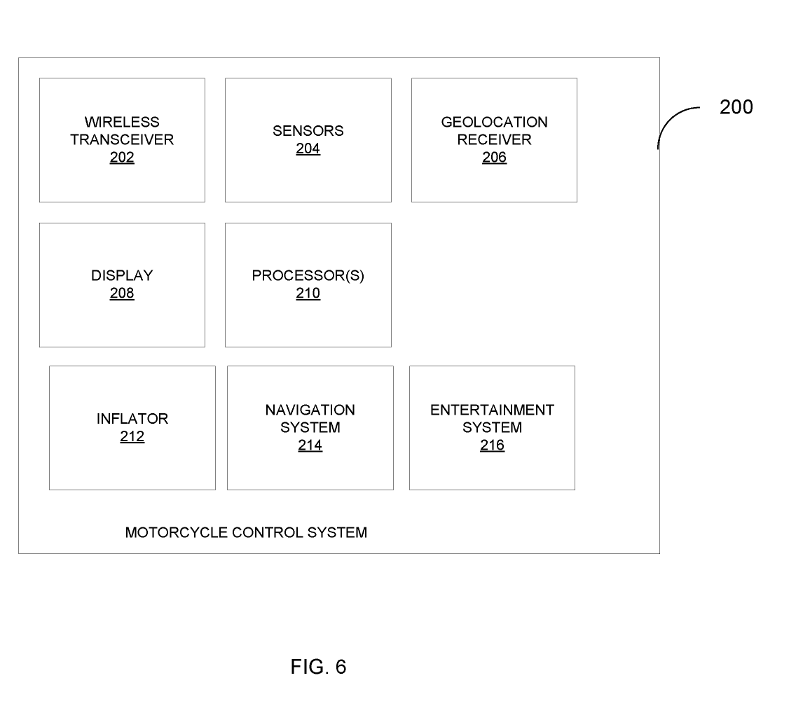

The earpiece(s) may also provide audio feedback to a user to convey information directly from the motorcycle or motorcycle control system. FIG. 6 illustrates one example of a simplified motorcycle control system 200 where one or more processors 210 are shown. The processors 210 may be operatively connected to a wireless transceiver 202, any number of sensors 204, a geolocation receiver 206, one or more displays 208, and one or more inflators 212 associated with one or more air bags, a navigation system 214, an entertainment system 216 or other systems. Information from the motorcycle may be communicated to the earpieces(s) to provide audio feedback. This may include turn-by-turn navigation based on information from the geolocation receiver 206 or associated navigation system 214, information from a built-in entertainment system 216, information for any number of sensors 204 which may be associated with any type of vehicle monitoring or other types of sensor, or other sensors. Some of this information may be the same as what is displayed on one or more displays 208 or alternatively, the information may be different than what is displayed to a user of the motorcycle.

### Input Pathways

As described above, the earpiece may have a touch surface for receiving gestural inputs or alternatively, one or more buttons or other manual inputs may be present on the earpiece. However, where a person wearing the earpieces also wears a helmet, the touch surface, manual inputs, or other types of user inputs may no longer be available to the user. The earpiece provides for termination of the input pathway into the device in response to detection of bilateral complete isolation of the touch surface from the person while wearing the device. In particular, the earpiece may sense that there is no connection to the world due to the blockage caused by the helmet. This allows the earpiece to prevent errant input signals which could be quite problematic while at the same time adjusting the input pathway expectations to predict voice control or gesture control input formats. However, the earpiece may determine that a user is wearing a helmet in any number of ways. This may include receiving user input that the user is putting on the helmet such as by a user selecting an activity mode associated with motorcycling. The user may select this input mode in any number of ways including via voice command. The earpiece may infer that the user is or will be putting on a helmet based on contextual information such as by sensor readings just prior to the helmet being put on and after the helmet being put on. For example, where sensors including optical sensors such as emitters and detectors sensor readings will detect light at normal conditions and then a transition to little light conditions due to the helmet. Additional sensor readings may be used to further confirm that the helmet is on. For example, the earpiece may emit an audio signal (audible or inaudible) from one or more of its speakers and then one or more microphones may receive the audio signal and process the audio signal to compare it to the signal transduced. Other types of audio processing may be used as well. For example, the change in environmental sounds with the helmet off and the helmet on. Another method of determination as to whether the helmet is on or off is receiving an active signal from the helmet through a wireless transceiver upon a user powering on a helmet where the helmet is so configured, or determining close proximity of the helmet to the earpiece such as by using a beacon associated with the helmet. Once the earpiece(s) have determined that the user has put on a helmet, the earpiece may then turn off sensors associated with the touch surface to prevent contact between the helmet and the sensors providing undesired input. Similarly, once the helmet has been removed, the sensors associated with the touch area may be re-activated.

### Charging

It is known that a helmet may include a battery such as for powering a display, communications or other purposes. Where the earpieces are in close proximity to a helmet, the helmet may be used for inductively charging the batteries of the earpieces. Thus, for example, when it is sensed that a user is wearing the earpieces and the helmet the earpiece may cease receiving user input from the touch surfaces and activate a charging mode. In the charging mode, the earpieces may be in close proximity to contacts on the helmet which allow for inductive transfer of power to thereby charge the battery. Thus, once it is determined that a user has the helmet on, the earpieces may be charged by the helmet of the battery.

It is further noted, that one way in which the earpieces may detect that the helmet is on and in a proper position is to determine if charge is being transferred from the helmet to the earpieces. If charge is being transferred, then this indicates that the helmet is on and in a sufficiently proper position to allow for power transfer and thus sensors associated with the touch surface of the earpiece may be turned off. Similarly, the earpiece may detect that charge is not being transferred which may indicate that the helmet has been removed.

### Crash Notification

Because the earpiece includes inertial sensors, the earpiece may detect motion patterns indicative of a crash. This may be detected by sudden changes in acceleration/deceleration such as those associated with impact. After such changes are detected with one or more inertial sensors, emergency measures may be taken. This may include making a phone call, sending a text message, or otherwise contacting emergency services. Information may be communicated about the location, the driver (or passenger) involved, health related information such as may be detected with one or more biometric or physiological monitors and other information.

### Protective System

According to another aspect, the helmet may include a protective system or safety system which may include one or more air bags. For example an air bag may be positioned to deploy from a helmet to protect a user's face, neck, or other portions of the user's head. Here, the earpiece may predict that a crash will take place and deploys the protective system prior to impact. A determination that a crash will occur may be performed in various ways. For example, changes in acceleration may indicate that a crash is likely. In addition to information sensed directly with the ear pieces, information from the motorcycle (or other vehicle) or the helmet may be used.

The motorcycle may be equipped with an air bag. Where the motorcycle is equipped with an air bag, a crash sensor of the motorcycle may be used or instead the inertial sensors of the earpiece may be used to detect a crash. An inflator may be used to emit a gas (such as nitrogen gas, carbon dioxide or other gas) to inflate the air bag nearly instantaneously.

Alternatively, one or more articles of clothing may be equipped with one or more air bags. For example, a jacket or jumpsuit, or other article of clothing may include an air bag and an inflator. Detection of a crash event with the earpieces may be communicated to the article of clothing to inflate the air bag. For example, the earpieces may be used in conjunction with an airbag collar such as that available from Hövding (Malmö, Sweden) (www.hovding.com). However, where an airbag collar is used, the collar does not need to include sensor electronics instead, it merely needs to be able to receive communications from the earpiece.

Another example of a jacket or jumpsuit with an air bag is available from Dainese (Italy) (www.dainese.com) under the D-AIR trade mark. Such an article of clothing may be equipped with a receiver or transceiver to receive communications from the earpiece such that the earpiece provides for activating the air bags when a crash event is detected or predicted. Thus instead of having accelerometers, gyroscopes, and GPS present in the clothing this type of electronics may be housed in the earpieces and used by the earpieces. Moreover, the jacket or jumpsuit or article of clothing need not have any user interface at all. For example, battery charge level or gas status may be communicated from the article of clothing to one or more earpieces.

### Coaching System

According to another aspect, a coaching system may be provided. The coaching system or training system may assist an inexperienced driver (or any driver) in improving their driving performance. The coaching system may provide feedback via audio to the driver. The audio may include voice instructions regarding when the driver should lean in a particular direction and how much the driver should lean in a particular direction. The amount of lean may be determined through use of the inertial sensor(s) in the earpieces alone or in combination with other inertial sensors present in the helmet, in the motorcycle, or in the clothing of the driver (such as present in driving boots or a jacket or racing suit or elsewhere). The instructions may also include instructions regarding speeding up, slowing down, making turns, changing lanes, avoiding other vehicles, or other instructions associated with safe or proper operation of a motorcycle.

Therefore various methods, systems, and apparatus have been shown and described herein. Although various embodiments have been shown it is to be understood that numerous variations, options, and alternatives are contemplated. This includes variations in the particular sensors of the earpiece, sensors of the helmet, sensors of the motorcycle, sensors of other articles of clothing or other sensors associated with the driver of the motorcycle. Of course, any number of variations in the structure, functions, and control methodologies are contemplated.

What is claimed is:

1. A system comprising:
a safety helmet;
an earpiece;
wherein the earpiece is configured to determine when a user of the earpiece is wearing the safety helmet.

2. The system of claim 1 wherein the earpiece comprises a touch surface and at least one sensor associated with the touch surface and wherein the earpiece is configured to ignore input at the touch surface when the user of the earpiece is wearing the safety helmet.

3. The system of claim 1 wherein 1 further comprising a battery disposed within the safety helmet and wherein the safety helmet is configured to charge a battery of the earpiece when the user is wearing the earpiece and the helmet.

4. The system of claim 3 wherein the battery is charged inductively.

5. The system of claim 1 further comprising at least one sensor in the safety helmet and wherein the safety helmet comprises a transceiver for communicating data from the at least one sensor in the safety helmet to the earpiece.

6. The system of claim 1 wherein the at least one sensor in the safety helmet comprises a plurality of microphone sensors.

7. The system of claim 1 wherein the at least one sensor in the safety helmet comprises an imaging sensor.

8. The system of claim 1 wherein the earpiece comprises an earpiece housing and at least one inertial sensor in the earpiece.

9. The system of claim 8 wherein the earpiece is configured to determine if a crash has occurred using data sensed by the at least one inertial sensor.

10. The system of claim 9 wherein the earpiece is configured to initiate a communication regarding a crash to a remote location if the earpiece has determined that the crash has occurred.

11. The system of claim 10 wherein the communication is a phone call.

12. The system of claim 10 wherein the communication is a text message.

13. The system of claim 10 wherein the communication comprises at least one of a location, an identify of the user, and physiological information of the user.

14. The system of claim 1 wherein the earpiece is configured to provide audio feedback of information derived from sensors of the helmet.

15. The system of claim 1 wherein the earpiece is configured to provide audio feedback of information derived from sensors of a motorcycle.

16. The system of claim 8 wherein the helmet comprises at least one air bag and wherein the earpiece is configured to send a signal to the helmet to deploy the at least one air bag if the earpiece determines that a crash is imminent using data from the at least one inertial sensor.

17. The system of claim 8 wherein the earpiece comprises a speaker and wherein the earpiece is configured to provide audio feedback to a user to assist in coaching the user in operating a motorcycle.

18. The system of claim 1 further comprising an article of clothing having an air bag and wherein the earpiece is configured to send a signal to the article of clothing to deploy the air bag.

19. The system of claim 18 wherein the article of clothing is selected from a set consisting of a race suit, a jacket, a vest, and a collar.

20. An earpiece comprising:
an earpiece housing;
a processor disposed within the earpiece housing;
a touch surface on an outer portion of the earpiece housing for receiving user input from a user;
wherein the earpiece is configured to determine when a user of the earpiece is wearing a safety helmet and to deactivate sensors associated with the touch surface if the user is wearing the helmet;
wherein the earpiece determines when the user of the earpiece is wearing the safety helmet by determining that sensor readings indicate that the safety helmet has been put on, receiving a user input that the user is putting on the safety helmet, receiving an active signal from the safety helmet that the safety helmet is powered on, determining that the safety helmet is in close proximity to the earpiece.
